(19) United States
(12) Patent Application Publication
(10) Pub. No.: US 2019/0078179 A1
(43) Pub. Date: Mar. 14, 2019

(54) Aluminum Anode Alloy

(71) Applicants: Craig Matzdorf, Hollywood, MD (US); Alan Grieve, Springfield, VA (US)

(72) Inventors: Craig Matzdorf, Hollywood, MD (US); Alan Grieve, Springfield, VA (US)

(73) Assignee: United States of America as represented by the Secretary of the Navy, Patuxent River, MD (US)

(21) Appl. No.: 15/704,721

(22) Filed: Sep. 14, 2017

(51) Int. Cl. C22C 21/00; H01M 4/46

(52) U.S. Cl. CPC C22C 21/00; H01M 4/463

(57) ABSTRACT

The aluminum anode alloy consists essentially of an aluminum base and effective amounts of tin and indium. The aluminum alloy is useful as a sacrificial metallic coating, as a protective aluminum anode, and as a pigment in polymeric coatings.

### ORIGIN OF INVENTION

The invention described herein was made by employees of the United States Government and may be manufactured and used by or for the Government for governmental purposes without the payment of any royalties thereon or therefor.

### FIELD OF THE INVENTION

The present invention is directed to aluminum alloys and to the use as a protective anode. The aluminum alloys can be used also as a sacrificial metallic coating and as a galvanic pigment in a binder or polymeric protective coating.

### BACKGROUND OF THE INVENTION

Aluminum anode alloys were initially researched and developed in the 1960's and 1970's. A body of patents and papers were published during this time which detail the exploration of various additive elements to aluminum which would activate it (inhibit the formation of aluminum oxide) and tune the operating potential, or voltage, to match that of pure zinc.

The development of activated aluminum alloys began in the 1960's and intellectual property is documented in U.S. Pat. Nos. 3,379,636 and 3,281,239 from Dow Chemical; U.S. Pat. No. 3,393,138 from Aluminum Laboratories Limited; and U.S. Pat. No. 3,240,688 from Olin Mathesin. All of these alloys were unique in that for the first time bulk aluminum alloys were shown to remain active and protect galvanically. Unfortunately, none were commercially successful as they all suffered from low efficiencies making them less economical than zinc anodes. During the 1970's Dow developed the aluminum-zinc-indium alloy, which they called Duralum III, which has very high efficiencies, approaching 90% of theoretical. This alloy became commercially available in 1988 with performance shown in FIG. 2. Since the commercialization of the Al-5% Zn-0.02% In and Al—Ga “low voltage” anode alloys, little progress has been made in the development of improved aluminum anodes.

Based on the world-wide use of the Al—Zn—In and Al—Ga anode alloys, this new technology has the potential to be used similarly. Aluminum anodes specified in MIL-DTL-24779 are currently supplied by qualified companies Galvotec Alloys, Inc., McAllen, Tex. and BAC Corrosion Control, Herfolge, Denmark. Additional commercial suppliers include Performance Metal/Caldwell Castings, Cambridge, Md.; Canada Metal (Pacific) Ltd., Delta, BC, Canada; and Harbor Island Supply, Seattle, Wash.

### SUMMARY OF THE INVENTION

The present invention relates to compositions of novel aluminum alloys designed to be coupled to materials with a higher operating potential (more positive) and act as a protective anode. The alloy could be used in bulk, applied by various methods as a sacrificial metallic coating, or made into a powder and used as a galvanic pigment in protective coatings such as a pigment in binders or polymeric coatings. The majority of the alloy is aluminum, with very small additions of tin (equal to or less than 0.2% by weight) and indium (equal to or less than 0.05% by weight) added to adjust the operating potential, activity, and efficiency of the alloys.

The novel feature of this invention is the very small addition of tin which is critical to control operating potential and efficiency. Prior art demonstrates aluminum anode alloys with tin, but higher amounts than the disclosed compositions. In addition, the efficiency of the higher tin alloys is low and thus not attractive for practical applications. Indium is added to stabilize the operating potential and enhance the efficiency of the alloys which would be otherwise lower if only tin were used.

The alloy compositions described herein are designed to have high operating efficiencies to make the alloy as cost-practical as possible, high current output to enable high and long-lasting performance for a given weight of anode (energy density), and optimized operating potential, which will vary depending on the application. An important added benefit is that the alloys of this invention do not contain zinc. The most used commercial aluminum anode alloy is aluminum-5% zinc-0.02% indium. This alloy is specified in MIL-DTL-24779 and has proven to be very effective in world-wide climates to protect a variety of materials including iron, steel, and aluminum piers, ships, off-shore rigs, and bridges among other applications. It is approximately 90% efficient, which is lower than pure zinc, which is about 98% efficient, but much higher than magnesium, which is about 60% efficient.

Unfortunately, zinc is an aquatic toxin and contains residual cadmium from the mining process. As such, many users are searching for a zinc-free alternative that has the same outstanding efficiency, current output and energy density. The alloy of this invention has the potential to replace the aluminum-zinc-indium alloy for use as described above. Moreover, Zinc is also more expensive than aluminum. The current spot price of zinc is $2.40 per kilogram versus aluminum, which is $1.77 per kilogram.

### DESCRIPTION OF THE DRAWINGS

FIG. 1 shows the typical operating potentials of aluminum, zinc and magnesium anodes. The aluminum-zinc-indium alloy was tailored to match the operating potential of zinc so that cathodic protection schemes already designed could be used and the aluminum anode could be used in place of zinc without causing over or under potentials in the system. This potential, approximately −1.10 volts versus standard calomel electrode (SCE) also happens to be in the “sweet spot” for protecting most types of steel and aluminum. So-called “high-strength steel” alloys with a tensile strength of approximately 160,000 pounds per square inch (psi), or higher, and Rockwell “C” hardness of 36 or higher, which are highly susceptible to hydrogen embrittlement, currently must use an alternative aluminum-gallium alloy that has an operating potential of about −0.850 volts versus SCE. This alloy is specified in MIL-DTL-24779.

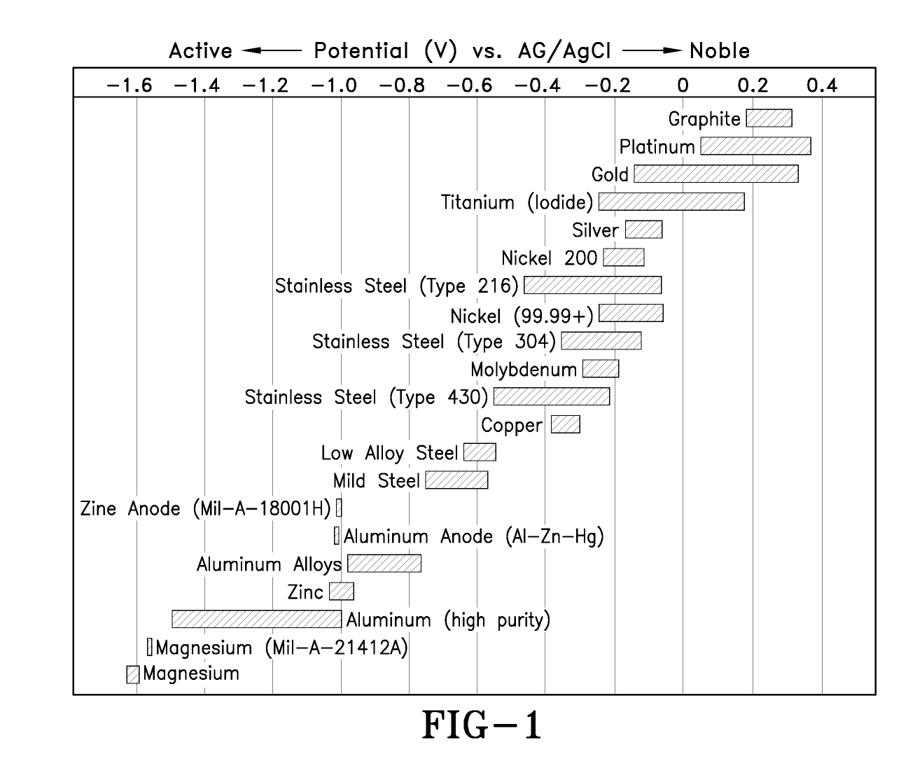

FIG. 2: Galvanic Anode Performance in 15% NaCl Solution at 75 C and 200 mA/ft2 (from Smith, S. N., Reding, J. T., and Riley, R. L, “Development of a Broad Application Saline Water Aluminum Anode—“Galvanic Ill”, Materials Performance, Vol. 17, 1978, pages 32-36.)

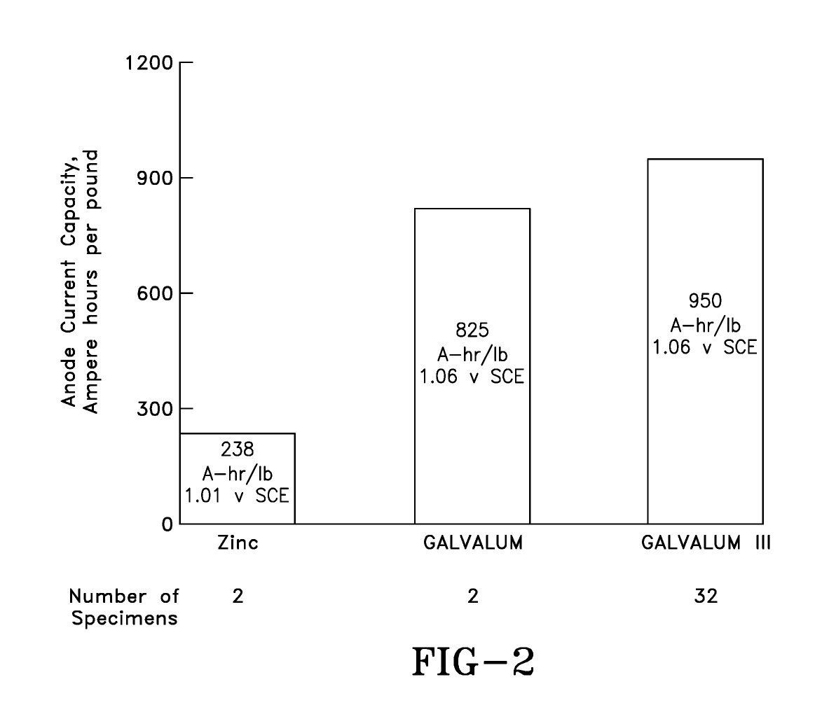

FIG. 3 shows open circuit potentials for two new Al—Sn—In alloys compared to the Al—Zn—In current control alloy.

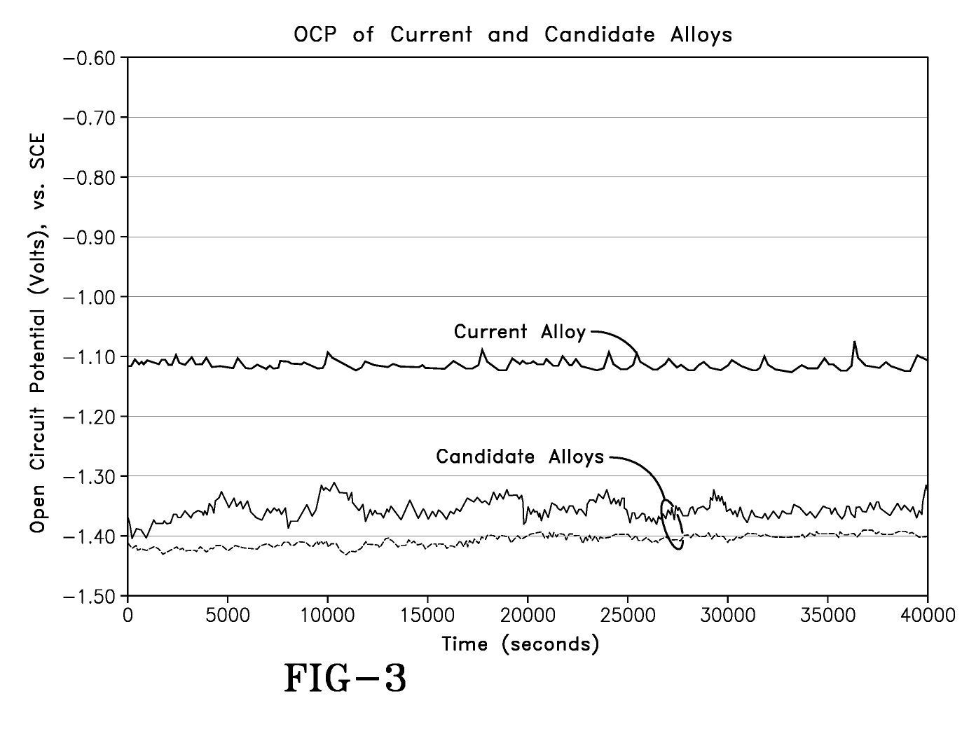

FIG. 4 shows anodic polarization curves for the same two new Al—Sn—In alloys compared to the current Al—Zn—In alloy.

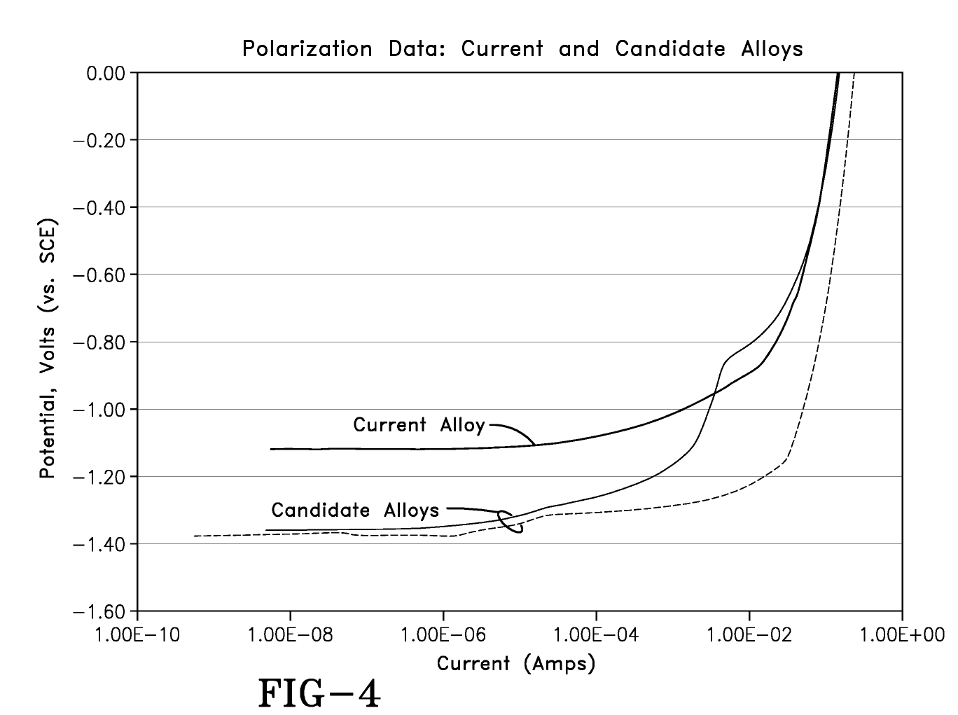

FIG. 5 shows the experimental set-up for measuring alloy efficiencies as reported in Table 1.

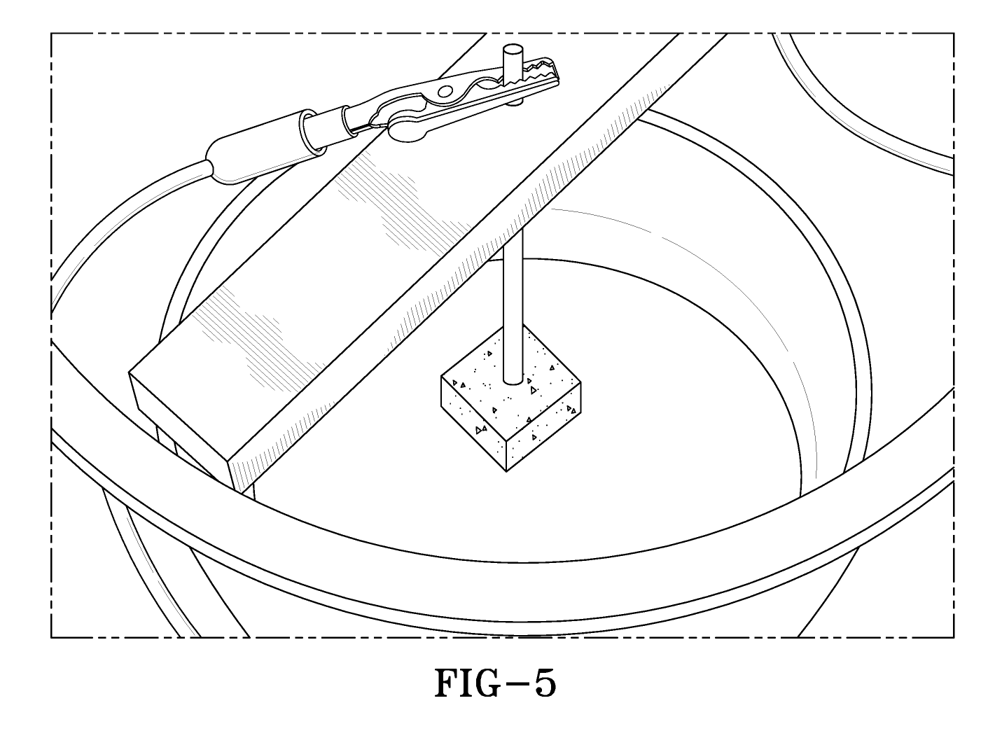

### DETAILED DESCRIPTION OF THE INVENTION

The important aspect of this invention is an aluminum anode alloy with the following ranges of composition:

Tin: 0.01 to 0.20 weight %

Indium: 0.005 to 0.05 weight %

Aluminum: balance

Impurities: per MIL-A-24779

Alloys with a range of tin and indium compositions were procured from Sophisticated Alloys, Butler, Pa. and ACI Alloys, Inc., San Jose, Calif. Compositions were melted in vacuum arc furnaces and cast into ceramic crucibles with no other heat treatments. Ingots were then sectioned into 0.5 inch thick “pucks”, ground and polished for electrochemical assessment. Separately, 1.0 inch cubes were also machined for efficiency testing. The anodes of the invention consist essentially of 99.9 percent by weight of aluminum and preferably high-purity aluminum of 99.99 percent by weight with tin ranging from about 0.01 to 0.20 percent and indium ranging from about 0.005 to 0.05 percent by weight.

The following weight percent alloys were assessed for operating potential efficiency and current output:
1. Al-0.20% Sn-0.02% In
2. Al-0.10% Sn-0.02% In
3. Al-0.05% Sn-0.02% In (current leading composition for coating pigment applications)
4. Al-0.04% Sn-0.04% In
5. Al-0.02% Sn-0.02% In (current leading composition for bulk anode and metallic sacrificial coating applications)
6. Al-0.02% Sn
7. Al-5.0% Zn-0.02% In (control)

Open circuit potential was assessed using a Gamry 600 potentiostat and flat specimen test cell. Test solution was 3.5% sodium chloride agitated with continuous air bubbler. Efficiency and current output was assessed using NACE Method TM0190, as required in MIL-DTL-24779. Efficiency, current capacity, operating potential and other important parameters are shown in Table 1 for the new alloys as well as references.

TABLE 1
Characteristics of Various Anode Materials

| | | | Current | |
|---|---|---|---|---|
| | | | Capacity | Open Circuit |
| | Density | Efficiency | (Amp- | Potential |
| Alloy Composition | (gm/cc) | (%) | hr/kg) | (V vs SCE) |
| Al—0.20%Sn—0.02%In | 2.704 | 46.4¹ | 1383¹ | −1.43 |
| Al—0.10%Sn—0.02%In | 2.702 | 55.5¹ | 1653¹ | −1.43 |
| Al—0.05%Sn—0.02%In | 2.701 | 72.5 | 2160 | −1.35 |
| Al—0.04%Sn—0.04%In | 2.701 | 79.9 | 2381 | −1.36 |
| Al—0.02%Sn—0.02%In | 2.701 | 92.6¹ | 2759¹ | −1.04 |
| Al—0.02%Sn | 2.700 | 91.4¹ | 2623 | −1.09 |
| Zinc² | 7.14 | ~98% | 820 | −1.05 |
| Magnesium² | 1.74 | ~60% | 1320 | −1.60 |
| Al—5.0%Zn—0.02%In² | 2.923 | 91.0¹ | 2613¹ | −1.12 |

¹Average of two specimens
²Reference anode material

The disclosed aluminum alloys have several advantages over existing technology. The elimination of zinc addresses the aquatic toxicity and residual cadmium issues in the currently used Al—Zn—In—In alloys. Zinc is also considered a strategic metal; its replacement with aluminum reduces reliance on metal supply from foreign countries. Minimal use of activator elements: zinc, indium and tin are all more expensive than aluminum, so the less used, the lower the anode cost. For the preferred alloy, only 0.04 weight percent of activators is used, contributing only $0.08 per kilogram of the anode. Lower weight density of the preferred alloy is 2.701 grams per cubic centimeter (gm/cc) compared to 2.923 gm/cc for the Al—Zn—In alloy due to the elimination of zinc, which is significantly more dense (7.14 gm/cc) than the aluminum (2.70 gm/cc) which replaces it. This translates to a 7% reduction in weight for the same sized (volume) anode, which is significant as anode cost is mostly driven by the commodity price of the constituent elements. The lower density (and weight) also should lead to lower shipping and handling costs as well as stress on the structures on which the anodes are attached.

With higher current capacity as shown in Table 1, the leading Al-0.02% Sn-0.02% In alloy has a superior current capacity compared to the commercially available Al—Zn—In alloy, zinc and magnesium. This is due to its high efficiency, lower density, and three electrons per atom for Al vs two for zinc and magnesium. With lower cost per Amp-hour due to the high current capacity and current commodity cost of the elements used in the various anodes, the subject invention has a superior cost per Amp-hour, which is a key factor for users and suppliers. Table 2 shows the spot prices for the elements. Table 3 shows the cost per kilogram of each alloy, and the cost per Amp-hour for each.

TABLE 2
Anode costs

| Element | Cost($/kg) | Source |
|---|---|---|
| Aluminum | 1.65 | Kitco, Oct. 3, 2016 |
| Indium | 400 | Estimate from web search |
| Magnesium | 3.56 | USGS Mineral Survey, |
| | | June 2016 |
| Tin | 20.26 | Infomine, Oct. 3, 2016 |
| Zinc | 2.40 | Kitco, Oct. 3, 2016 |

TABLE 3
Anode cost per Amp-hour (based on spot price -
does not include cost to cast and ship anode)

| | | Cost/Amp-hour |
|---|---|---|
| Anode | Cost per kg ($) | (cents/A-hr) |
| Al—5%Zn—0.02%In | 1.77 | 0.07 |
| Zinc | 2.40 | 0.29 |
| Magnesium | 3.56 | 0.27 |
| Al—0.02%Sn—0.02%In | 1.73 | 0.06 |

The use of the aluminum alloy pigments of this invention in a binder or coating composition allows the corrosion-inhibiting aluminum pigment to be applied on substrates of different metals while improving the corrosion resistance of one metal without increasing the corrosion of a different metal component. The method comprises using a binder or coating on the metal which includes an effective amount of the aluminum alloy of this invention. The coatings can include organic systems such as a simple binder or an organic coating including paints and various other known metal inorganic or organic coatings.

For example, the binder or polymeric coating can range from about 50 to 90% or even up to about 99% or parts by weight of the total composition and the aluminum alloy pigment can range from about 0.1% up to 30% by weight of the binder or coating. The coatings include inorganic, polymeric or organic binders, such as paints, lubricants, oils, greases and the like.

Suitable binders include the polyisocyanate polymers or prepolymers including, for example, aliphatic polyisocyanate prepolymers, such as 1,6-hexamethylene diisocyanate homopolymer (“HDMI”) trimer and aromatic polyisocyanate prepolymers, such as 4,4′-methlenediiphenylisocyanate (“MDI”) prepolymer. A preferred binder for the aluminum alloy pigment comprise the polyurethanes, and more particularly the aliphatic polyurethanes derived from the reaction of polyols and multifunctional aliphatic isocyanates and the precursors of the urethanes.

Other binders include the epoxy polymers or epoxy prepolymers, for example, the epoxy resins, including at least one multifunctional epoxy resin. Among the commercially available epoxy resins are polyglycidyl derivatives of phenolic compounds, such as the tradenames EPON 828, EPON 1001 and EPON 1031.

While this invention has been described by a number of specific examples, it is obvious that there are other variations and modifications which can be made without departing from the spirit and scope of the invention as particularly set forth in the appended claims.

The Invention claimed:

1. An aluminum base alloy consisting essentially of 0.01 to 0.20 percent by weight of tin, 0.005 to 0.05 percent by weight of indium and the balance aluminum.

2. The aluminum alloy of claim 1 wherein the aluminum base is at least about 99 percent by weight.

3. The aluminum alloy of claim 1 wherein the aluminum base is at least about 99.9 percent pure.

4. A metallic sacrificial coating consisting essentially of an aluminum base of about 0.02 percent by weight of indium, from about 0.02 percent by weight of tin and the balance aluminum.

5. The sacrificial coating of claim 4 wherein the aluminum is at least 99.9 percent pure.

6. A pigment for polymeric coatings consisting essentially of an aluminum base containing about 0.05 percent by weight of tin, about 0.02 percent by weight of indium and the balance aluminum.

7. The pigment of claim 6 wherein the aluminum base is at least 99.9 percent pure.

8. A corrosion-resistant coating consisting essentially of a major amount of a polymeric coating and an effective amount of an aluminum alloy consisting from 0.01 to 0.20 percent by weight of tin, 0.005 to 0.05 percent by weight of indium and the balance aluminum.

9. The coating of claim 8 wherein the polymeric coating consist essentially of an epoxy polymer.

10. The coating of claim 8 wherein the polymeric coating consist essentially of polyurethane.

11. A corrosion-resistant coating consisting of a major amount of binder and an effective amount of an aluminum alloy consisting essentially of 0.01 to 0.20 percent by weight of tin, 0.005 to 0.05 percent by weight of indium and the balance aluminum.

12. The corrosion-resistant coating of claim 9 wherein the aluminum is at least 99.9 percent pure.

13. Polymeric coatings consisting essentially of an aluminum base containing from about 0.05 percent by weight of tin, from about 0.02 percent by weight of indium and the balance aluminum.

14. The coatings of claim 13 wherein the aluminum is at least 99.9 percent pure.

15. The coatings of claim 13 wherein the aluminum s 99.99 percent pure.
